(19) United States
(12) Patent Application Publication
(10) Pub. No.: US 2012/0115697 A1
(43) Pub. Date: May 10, 2012

(54) METHOD AND DEVICE FOR INSERTING OBJECTS INTO AN ENDLESS FILTER ROD OF THE TOBACCO PROCESSING INDUSTRY

(75) Inventors: Joern PUNZIUS, Trittau (DE); Heiko ZIESMANN, Sahms (DE); Andreas PANZ, Geesthacht (DE)

(73) Assignee: HAUNI MASCHINENEBAU AG, Hamburg (DE)

(21) Appl. No.: 13/289,326

(22) Filed: Nov. 4, 2011

(30) Foreign Application Priority Data
Nov. 5, 2010 (DE) 102010043474.4

(51) Int. Cl. B31C 99/00

(52) U.S. Cl. 493/42

(57) ABSTRACT

Method and device for inserting objects into at least one endless filter rod of the tobacco processing industry that is conveyed in the longitudinal axial direction. The method includes creating at least one blind hole-like recess in the at least one endless filter rod, inserting at least one object into the at least one blind hole-like recess in an insertion zone; and compacting the at least one endless filter rod to enclose the object.

### CROSS-REFERENCE TO RELATED APPLICATIONS

The present application claims priority under 35 U.S.C. §119(a) of German Patent Application No. 10 2010 043 474.4 filed Nov. 5, 2010, the disclosure of which is expressly incorporated by reference herein in its entirety.

### BACKGROUND OF THE INVENTION

1. Field of the Invention

The invention relates to a method for inserting objects into an endless filter rod of the tobacco processing industry. The endless filter rod is conveyed in the direction of the longitudinal axial direction. At least one object is inserted into the endless filter rod in an insertion zone and the endless filter rod is subsequently compacted so that the object is enclosed by the endless filter rod. The invention further relates to a device for inserting objects into an endless filter rod of the tobacco processing industry. The device includes a rod conveying device for conveying an endless filter rod in the longitudinal axial direction, and an object conveying device for objects to be inserted into the endless filter rod. The object conveying device defines a conveying track for the objects, which leads from a transfer position, at which the objects are transferred to the object conveying device, to an insertion zone, in which the objects are inserted into the endless filter rod. Finally, the invention relates to a machine of the tobacco processing industry.

Thus, the invention relates to the production of an endless filter rod for rod-shaped articles of the tobacco processing industry, in particular for cigarettes and filtered cigarettes, where the endless filter rod, after its production, is cut to length into individual filter rods. The endless filter rod or the cut filter rods contain one or more objects as essential components which influence filtering properties. The objects can be capsules, which are filled, in particular, with a fluid. The fluid in such cases typically contains flavoring agents or fragrances, e.g., menthol. A smoker breaks open the capsule by applying pressure on the filter before he lights the cigarette. The fluid is thereby released and the aroma of the fluid develops. This procedure offers a particularly intensive or fresh taste experience. Such capsules typically have a diameter of approximately 3 mm, but can also have a smaller diameter.

Alternatively, hard objects can also be used as objects, as well as smaller or larger particles, e.g., pellets or cylindrical objects of active charcoal, extrudates, or other filter materials or additives.

2. Discussion of Background Information

A generic technology, according to International Publication No. WO 2005/032286 A2, the disclosure of which is expressly incorporated by reference herein in its entirety, includes an insertion device for capsules in a filter tow strip having a rotating insertion wheel. The insertion wheel, on its periphery, has retainers for capsules in which the capsules are held after the insertion via of suction air. During the further rotation of the insertion wheel, the periphery of the insertion wheel continuously penetrates into the filter tow strip. In this case, as soon as a capsule enters into the filter tow strip, the suction air is switched off. Thus, the capsule is deposited in the filter tow strip and transported further with it. At the location of the insertion wheel, the filter tow strip substantially is given the shape of a “U”, wherein the insertion wheel forms the center recess or respectively the channel of the “U”. Then, the formation of the endless filter rod is realized in which the filter tow strip is closed, compacted and enclosed using a strip of plugwrap.

After placement of capsules into a filter tow strip, the capsules according to International Publication WO 2005/032286 A2, are not yet completely secured in the filter tow strips. This occurs only after a subsequent rod formation and enclosing using a plugwrap. In the period, or respectively on a conveyor path between inserting the capsules and securing by forming the rod, the capsules in the filter tow strips can still slip or completely fall out.

Filters, which are produced from sections of the filter tow having slipped or missing capsules, represent undesired rejects. They are detected in a later step of the method for the production, either already in the endless filter rod or in the filter rods cut to length therefrom, or in the case of producing multi-segment filters, in the produced filter segments. The affected filter rods or filter segments are sorted out, or rejected.

The conveying of a filter tow strip and an endless filter rod formed therefrom in a filter rod machine occurs continuously. The production speed and the conveyor speed of the filter tow strip and the endless filter rod formed therefrom, are limited by the maximum speed of the insertion device for the objects being inserted into the endless filter rod. Currently, the maximum speed amounts to approximately 100 meters per minute. This production speed is significantly lower than with customary filter rods, which do not have inserted capsules.

The filters provided with the inserted capsules, despite a typical application of plasticizers, in particular triacetin, have a relatively soft and loose consistency compared to other filters, due to the comparatively low production speed and low speed with which the filter tow preparation previously was realized, and therefore are less robust than conventional filters without capsules. In addition, the filtering properties of filters having capsules are limited because of this.

### SUMMARY OF THE EMBODIMENTS

Based on this prior art, embodiments of the present invention provide a method for manufacturing an endless filter rod of the tobacco processing industry and a corresponding filter rod machine, with which it is possible to produce an endless filter rod and filters with inserted capsules, which have higher strength and improved filter properties. In addition, the reject rate of filter rods with missing or incorrectly positioned objects, in particular fluid-filled capsules, is reduced.

According to the embodiments, a method for inserting objects into an endless filter rod of the tobacco processing industry, in which the endless filter rod is conveyed into the longitudinal axial direction, includes at least one object being inserted into the endless filter rod in an insertion zone, and the endless filter rod being subsequently compacted. The object is enclosed by the endless filter rod and the method further includes at least one object being inserted with the creation of a blind hole-like recess in the endless filter rod.

The insertion of objects into the endless filter rod is therefore realized according to the invention departing from the typical methods in the prior art in which a continuous and through-running channel is created using an insertion wheel. Instead, each object is inserted individually using the creation of a blind hole-like recess in the endless filter rod. In particular, the insertion is realized by way of a pinpoint piercing, with which the blind hole-like recess is created.

The creation of a blind hole-like recess means that a recess is created in the endless filter rod, substantially only at a point, i.e., in the immediate vicinity of the object. Because each object is inserted into the endless filter rod with a blind hole-like recess, its position is fixed in the longitudinal direction of the endless filter rod. Thus, the object cannot slip in the longitudinal axial direction of the endless conveyor rod, as with the prior typical channels, which slipping leads to undesired rejects.

In addition, because the recesses are only present in each case locally distinct from each other, improved and increased strength results in the subsequent final formation of the endless the filter rod, because there is no continuous channel which needs to be closed. The produced endless filter rod is overall more homogeneous than was previously possible. With this, the filtering properties are improved.

By using blind hole-like recesses, in which the objects are held in the endless filter rod, the accuracy of positioning the objects is substantially increased over the prior accuracy. In this manner it is possible to use substantially smaller or respectively shorter segments than were previously used, for example in the production of multi-segmented filters. In addition, the endless filter rod can be moved with greater or respectively faster speed, because the danger of the object slipping or rolling away at higher speed no longer exists, as was the case with the prior art.

Objects in the scope of the invention are, among others, fluid-filled capsules, extrudates or solid filter materials or additive materials, for instance activated charcoal.

Advantageously, the at least one object, before insertion, is conveyed on a section of a circular or elliptical, or essentially circular or elliptical track or on a section of a track, which results from superimposing a circular or elliptical track with a further curved track. Such a tract permits the relative speed of the objects to be matched to the speed of the endless filter rod in its conveyance direction.

For this purpose, in the insertion zone the endless filter rod runs tangentially to the track, wherein the conveyance speed of the objects during insertion in the insertion zone in the conveyance direction of the endless filter rod is the same or substantially the same as the conveyance speed of the endless filter rod. The insertion zone typically has an extent of several centimeters along the endless filter rod. In this area, the track of objects approaches the endless filter rod, reaches its turning point or respectively tangent point at which the object is inserted into the endless filter rod, and withdraws again from the endless filter rod. The second speed component of the object is perpendicular to the direction of the endless filter rod. The value of this speed component vanishes at the turning point. This perpendicular component corresponds to the piercing into the endless filter rod and the creation of the blind hole, whereas the parallel component corresponds to matching the speed of the objects to the speed of the endless filter rod.

Therefore, the speed component of the objects parallel to the endless filter rod varies slightly and experiences its maximum at the turning point. This leads to the fact that the shape of the blind hole-like recess is not completely regular, but rather somewhat broadened in the direction of the rod. This can be reduced by superimposing several motion components, for example by a multi-axis lever kinematic. The broadening of the blind hole-like recess can also be reduced by selecting an elliptical shape for the track, wherein in particular the penetration into the endless filter rod occurs in the flattest part of the elliptical track. Appropriate elliptical tracks can be attained via planetary gears, for example.

Preferably, during the creation of the blind hole-like recess, the at least one object is pressed unprotected into the endless filter rod, or is protected from direct stress. The initially named case offers a particularly simple method of construction because protective measures are not necessary for the object. In the case of fluid-filled or powder-filled capsules or granulates, for example activated charcoal, protection of the capsules during creation of the blind hole-like recess is however advantageous. Harder objects, such as hard pellets of activated charcoal, extrudates or similar objects, do not need to be protected and can be used as a drill head or piercing head for creating the blind hole-like recess.

The shape of the object is not restricted in the scope of the invention. The objects can be spheres, such as the fluid-filled capsules, however they can also be cylindrical objects, for example extrudates, that are inserted longitudinally axially, or any other regular or irregular shape.

The objects are preferably held on the object conveying device. This occurs advantageously in that the at least one object before insertion into the endless filter rod is held by suction air on a receiving element, which in particularly is rod-shaped at least in sections or substantially rod-shaped, and is transferred to the endless filter rod in the insertion zone, in particular by switching off the suction air and/or switching on compressed air. Here, a substantially rod-shaped receiving element is understood to be a longitudinally extending receiving element. The cross-section of the receiving element can be round or polygonal, or also can have rounded corners and/or side surfaces. Such a receiving element penetrates with its tip into a filter strip and creates a blind hole-like recess there.

In an advantageous further development it is provided that the endless filter rod is compacted in the insertion zone, and/or is pre-compacted before the insertion of the at least one object, to a density which lies between a density of an uncompacted and/or unformed endless filter rod and a compacted and formed endless filter rod. In the case of a pre-compacted endless filter rod, the object in the blind hole-like recess is additionally held securely by the pressure exerted by the surrounding filter rod material.

During insertion, the diameter of the endless filter rod remains constant or decreases. The latter corresponds to the case in which the insertion zone coincides with a compaction zone. In this case also, it is preferable to pre-compact the endless filter rod already before the start of the insertion zone.

Preferably several objects are inserted simultaneously into the endless filter rod, each with creation of their respective own blind hole-like recesses, wherein the several objects are each conveyed on equally dimensioned circular or elliptical tracks, which are shifted in parallel with respect to each other in the conveyance direction of the endless filter rod by a preset or pre-settable distance. This further development leads to a significant increase of the possible production speed.

The insertion of an individual object, for example fluid-filled capsules, is currently realized at a rate of approximately 3,000 objects per minute. This production rate is limited by the speed with which the capsules can be removed from a magazine, because they are comparatively sensitive and react to excessive force. If several objects are inserted into the endless filter rod in parallel or respectively simultaneously, the corresponding number of objects can be removed in parallel out of a corresponding number of magazines so that it is possible to increase the speed by the corresponding multiple. For example in the case of five objects inserted in parallel, even in the case of fluid-filled capsules, in this way it is possible to attain a speed of 15,000 objects being inserted per minute into the endless filter rod. In this manner, it is also possible to implement a very high density of the occupancy of the endless filter rod with objects, which previously was not possible with the conventional insertion wheels. At the same time, the filter rod conveyor speed can be increased.

In order for the paths or respectively tracks of these objects not to cross before their insertion into the endless filter rod, they are conveyed according to the invention on equally dimensioned circular or elliptical shaped tracks that are shifted in parallel with respect to each other in the conveyance direction of the endless filter rod.

A further increase of the production speed of endless filter rods loaded with objects is advantageously attained if at least one object each is inserted in each case into at least two endless filter rods conveyed in parallel to each other in the longitudinal axial direction in each case with the creation of a blind hole-like recess. Therefore, with a twin rod machine, it is possible to achieve a doubling of the production speed. In addition, more than two filter rods can also be created in this way.

The objective of the invention is also solved by a device for inserting objects into an endless filter rod of the tobacco processing industry, comprising a rod conveying device for conveying an endless filter rod in the longitudinal axial direction, and an object conveying device for objects to be inserted into the endless filter rod, wherein the object conveying device defines a conveying track for the objects which leads from a transfer position, at which the objects are transferred to the object conveying device, to an insertion zone, in which the objects are inserted into the endless filter rod, the device being further developed in that the object conveying device has receiving elements for objects to be inserted into the endless filter rod, wherein the receiving elements are designed essentially rod-shaped at least in sections, and each have a receiving seat in the area of their tip with a retaining device for an object, wherein for inserting an object into the endless filter rod in the area of the insertion zone, the receiving element is aligned essentially perpendicular to the endless filter rod, the endless filter rod being disposed tangentially to the conveying track, and a conveying speed of the objects in the rod conveying direction is matched to a rod conveying speed, so that a receiving element dips into the endless filter rod with the creation of a blind hole-like recess.

Likewise, as with the method according to the invention, the objects with the device according to the invention, are inserted into the endless filter rod, creating a blind hole-like recess in an insertion zone at a turning point or respectively tangent point of the track of the object. With this, the objects are held in the blind hole-like recesses in the endless filter rod and secured against slipping along the longitudinal axis. The recesses are created by the rod-shaped receiving elements which dip into the endless filter rod for inserting the objects.

A receiving element that is essentially rod-shaped, at least in sections, in the scope of the invention is understood to be a receiving element that at least in the section at its tip, which dips into the endless filter rod for inserting an object, is substantially rod-shaped. This section is preferably substantially extended longitudinally. The cross-sectional shape of this section can be round, or polygonal, or can also have rounded corners and/or side surfaces.

For inserting the objects into the endless filter rod, preferably each rod-shaped receiving element in the area of the insertion zone is aligned essentially perpendicularly to the endless filter rod, in order to dip into the endless filter rod for creating a blind hole-like recess. The tangential alignment of the endless filter rod to the conveying track of the objects, and matching the conveyor speed of the objects in the rod conveyance direction to the rod conveyor speed serve for creating the blind hole-like recesses, as they are described above in connection with the method according to the invention.

Preferably the conveying track between the transfer position and the insertion zone describes a section of a circular or elliptical, or substantially circular or elliptical track, or a section of the track that results from superimposing a circular or elliptical track with a further curved track.

Preferably, the receiving seat is disposed at the tip of the receiving element, or the receiving element has an extension at its tip, which protects the at least one object from direct stress during the creation of the blind hole-like recess. The second alternative is particularly advantageous for inserting fluid-filled capsules into an endless filter rod. The extension is shaped so that it protects the object from damaging stress during the creation of a blind hole-like recess as well as permitting its insertion into the recess.

Advantageously, the retaining device is a suction air connection, in particular controllable, or a, in particular releasable, clamping mechanism. A suction air connection, which according to the invention can be connected also to compressed air, is suitable in particular for objects with uniform surfaces, for example spherical objects or cylindrical objects, whereas a clamping mechanism is used preferably for irregularly shaped objects.

Preferably it is provided that the insertion zone is disposed between a garniture tongue and a garniture device or format for the endless filter rod, and/or the endless filter rod in the insertion zone has a diameter that is decreasing conically in the conveyance direction. With this, particularly in the case of pre-compaction, it is possible to insert the objects into a pre-compacted endless filter rod so that the objects are held more securely in the endless filter rod. The combination of the insertion zone with a compaction zone is used for shortening the entire device.

A multiplication of the production speed is possible, if, preferably, at least two receiving elements are provided displaced or offset with respect to each other, for inserting objects into at least two endless filter rods conveyed longitudinally axially in parallel to each other.

In a preferred design, it is provided that several rod-shaped receiving elements are disposed in parallel in a row or in several rows on a common insertion shoe, which rotates on the object conveying device on a circular or elliptical track, wherein the insertion shoe can be rotated about an axis of rotation, which is perpendicular to the plane spanned by the track, in particular for maintaining the orientation of the shoe in the course of the track. Preferably, the object conveying device has, in particular, several insertion shoes of the same kind. With the insertion shoes and the receiving elements disposed thereupon in a row or in several rows, it is possible to define for each object on each of the receiving elements its own circular track or elliptical track, which are respectively displaced in parallel to each other.

The receiving elements of each suction shoe are disposed symmetrically or asymmetrically. Larger distances are preferably provided between receiving elements where an enlarged gap is provided between the objects in the endless filter rod at a position, at which filter rods are cut to length from the endless filter rod. Alternatively or additionally, it is provided for this purpose that the receiving elements of an individual suction shoe are provided for a filter rod of one or several use lengths, and an enlarged gap is maintained between subsequent suction shoes.

If the receiving elements are disposed on the insertion shoes in several rows, multiple endless filter rods can be created simultaneously with inserted objects.

Preferably the conveying track proceeds between the transfer position and the insertion zone in an arc of approximately 90° to 180°. Here, the insertion zone is preferably located in the lower turning point and the transfer position approximately 90° to 180° in front of it, or respectively upstream in the flow in the object conveyance direction. This selection permits a constructive arrangement of preceding drums that is particularly simple.

Preferably a magazine is provided for objects to be inserted and a pick-up drum is provided for removing objects from the magazine. The axis of rotation can, in particular, be aligned parallel to the endless filter rod.

In an advantageous variant, the pick-up drum is designed for transferring the objects to the object conveying device, in particular by way of radially slidable suction rods. This can be implemented such that the suction rods, which can also be designated as suction tubes, are maximally withdrawn during a circulation of the pick-up drum in the area of the magazine, and radially retracted below the peripheral surface of the pick-up drum, so that a trough is formed at the surface of the pick-up drum. This way, objects from the magazine can arrive in the trough, in particular by suction air. In the course of rotation towards the object conveying device, the suction rods are pushed out in the radial direction beyond the peripheral surface of the pick-up drum so that the objects are held on the tip of the suction rod, and are transferred at a transfer position to the object conveying device or respectively the receiving elements. The radial movement of the suction rods can be controlled using a mechanical control cam or using electrical actuators, or other controllable drive unit.

In an alternative embodiment, a transfer drum with suction rods is additionally provided that is designed for receiving objects from the pick-up drum and for transferring the objects to the object conveying device. The applicable suction rods need not be radially slidable. In any case, the subsequent insertion shoes with their receiving elements can receive the objects via the suction rods, which extend at least in the area of the receiving position beyond the periphery of the transfer drum.

Preferably, a part of the suction rods is provided with a folding mechanism for transferring two or more objects. A corresponding folding mechanism can be seen, for example, in the German patent DE 41 29 672 C2 from the applicant whose disclosed content should be incorporated by reference completely in this present patent application. Using the folding mechanism, the foldable suction tubes can be unfolded in the receiving area in order to transfer several rows of objects to an insertion shoe. This is advantageous, particularly with twin or multiple rod machines.

Preferably, the magazine, the pick-up drum and/or the transfer drum are structured modularly, in particular the pick-up drum and/or the transfer drum having drum disks whose number and distance can be adjusted to each other. The modularity and, in particular, the adjustability of the number and distances makes it possible to use the device for different formats and for different products with different specifications, such as to produce the population with objects of a desired filter. In this way, different objects can also be disposed in a filter. In addition, a filter segment for a filter cigarette can be populated in this manner with different objects, for example different capsules. In the case that only the pick-up drum, but not the transfer drum, is provided, the modular construction relates only to the pick-up drum. In the case that both are provided, that is the pick-up drum and the transfer drum, the modular construction relates preferably to both drums.

Embodiments of the invention are directed to a machine of the tobacco processing industry, in particular a filter rod machine that includes the device according to the invention as described above.

Embodiments of the invention are directed to a method for inserting objects into at least one endless filter rod of the tobacco processing industry that is conveyed in the longitudinal axial direction. The method includes creating at least one blind hole-like recess in the at least one endless filter rod, inserting at least one object into the at least one blind hole-like recess in an insertion zone; and compacting the at least one endless filter rod to enclose the object.

According to embodiments of the invention, before inserting the at least one object, the method includes conveying the at least one object on one of: a section of a circular or elliptical track; a section of a substantially circular or elliptical track; or a section of a track including a superimposing of a circular or elliptical track with a further curved track. The endless filter rod in the insertion zone is conveyed tangentially to the track. A conveyance speed of the object during insertion in the insertion zone in the conveyance direction is at least essentially the same as the conveyance speed of the endless filter rod.

In accordance with other embodiments, the at least one object during the creation of the blind hole-like recess, is pressed one of unprotected into the endless filter rod or protected from a direct stress.

The method can also include before inserting the at least one object into the endless filter rod, holding the at least one object on a receiving element via suction air, and, in the insertion zone, transferring the at least one object to the endless filter rod by at least one of switching off the suction air and supplying compressed air.

According to still other embodiments of the instant invention, the method can include at least one of: compacting the endless filter rod in the insertion zone; and precompacting the endless filter rod before the insertion of the at least one object to a density that lies between the density of at least one of an uncompacted and unformed endless filter rod and a compacted and formed endless filter rod.

In accordance with other embodiments, several objects are simultaneously inserted into respectively created recesses in the endless filter rod. The several objects are conveyed on equally dimensioned circular or elliptical tracks that are shifted in the conveyance direction of the endless filter rod in parallel with respect to each other by a preset or presettable distance.

Further, the at least one filter rod comprises at least two endless filter rods conveyed longitudinally axially in parallel to each other, and the method further comprises inserting at least one object in blind hole-like recesses created in the at least two filter rods.

Embodiments of the invention include a device for inserting objects into an endless filter rod of the tobacco processing industry. The device includes a rod conveying device for longitudinal axial conveyance of an endless filter rod, and an object conveying device for objects to be inserted into the endless filter rod that defines a conveying track for the objects leading from a transfer position, at which the objects are transferred to the object conveying device, to an insertion zone, in which the objects are inserted into the endless filter rod. The object conveying device includes receiving elements structured for receiving objects to be inserted into the endless filter rod that are substantially rod-shaped at least in sections, in which each endless filter rod has a receiving seat with a retaining element in an area of a tip for an object. Further, the receiving elements are essentially perpendicularly alignable with the endless filter rod for inserting an object into the endless filter rod in the area of the insertion zone, in which the endless filter rod is disposed tangentially to the conveying track. The device also includes a device for controlling a conveying speed of the objects in the rod conveying direction to match to a rod conveying speed so that the receiving elements dips into the endless filter rod to create blind hole-like recesses.

In accordance with embodiments of the invention, the conveying track between the transfer position and the insertion zone describes one of: a section of a circular or elliptical; a section of a substantially circular or elliptical track, or a section of a track that results from superimposing a circular or elliptical track with a further curved track.

According to other embodiments of the instant invention, one of: the receiving seat is located at a tip of the receiving element, or the receiving element has a projection at its tip that protects the at least one object from a direct stress during creation of the blind hole-like recess.

According to still other embodiments, the retaining element is one of a controllable, suction air connection, or a releasable clamping mechanism.

Further, at least one of: the insertion zone is located between a split garniture tongue and a garniture device for the endless filter rod, and the endless filter rod entering the insertion zone has a conically decreasing diameter in the conveyance direction.

According to still other embodiments, at least two receiving elements are arranged offset to each other for inserting objects into at least two endless filter rods conveyed longitudinally axially parallel to each other.

In accordance with further embodiments, the rod-shaped receiving elements are disposed parallel in at least one row on a common insertion shoe that rotates on a circular or elliptical track on the object conveying device. The insertion shoe can be rotated to maintain its orientation in the course of the track, about an axis of rotation that is perpendicular to the plane spanned by the track.

According to other embodiments, the conveying track between the transfer position and the insertion zone comprises an arc of approximately 90° to 180°.

Moreover, the device further includes a magazine for objects to be inserted; and a pick-up drum for removing objects from the magazine. The pick-up drum is structured and arranged to transfer the objects to the object conveying device. The pick-up drum comprises radially slidable suction rods. The device also can include a transfer drum structured with suction rods and arranged to receive objects from the pick-up drum and to transfer the objects to the object conveying device. For transferring two or more rows of objects, a part of the suction rods comprises a folding mechanism. At least one of the magazine, the pick-up drum and the transfer drum are modularly structured with drum disks of at least one of the pick-up drum and the transfer drum having a number and distance to each other that is adjustable.

In accordance with still yet other embodiments of the present invention, a machine of the tobacco processing industry can include the above-described device.

The described features, properties and advantages of the different subject matters of the invention, i.e. the method, the device and the machine, are applicable also for the respective other subject matters, even if these were not explicitly mentioned in connection with the other subject matters.

Further characteristics of the invention will become apparent from the description of the embodiments according to the invention together with the claims and the included drawings. Embodiments according to the invention can fulfill individual characteristics or a combination of several characteristics.

### BRIEF DESCRIPTION OF THE DRAWINGS

The invention is described below, without restricting the general intent of the invention, based on exemplary embodiments, wherein reference is made expressly to the drawings with regard to the disclosure of all details according to the invention that are not explained in greater detail in the text.

In the drawings, the same or similar types of elements or respectively corresponding parts are provided with the same reference numbers in order to prevent the item from needing to be reintroduced.

FIG. 1 illustrates a schematic perspective representation of a device according to the invention;

FIG. 2 illustrates a schematic perspective detail representation of a device according to FIG. 1;

FIG. 3 illustrates an additional schematic perspective detail representation of a device according to FIG. 1;

FIG. 4 illustrates an additional schematic perspective detail representation of a device according to FIG. 1;

FIG. 5 illustrates an additional schematic perspective detail representation of a device according to FIG. 1;

FIG. 6 illustrates a schematic perspective representation of an insertion shoe;

FIG. 7 illustrates a schematic front view of a device according to the invention;

FIG. 8 illustrates a schematic representation of an endless filter rod in a device according to the invention;

FIG. 9 illustrates a schematic cross-sectional representation through an endless filter rod according to FIG. 8;

FIG. 10 illustrates a schematic representation of a conveyance principle according to the invention;

FIG. 11 illustrates a schematic representation of a device according to the invention for a twin filter rod machine;

FIG. 12 illustrates a systematic perspective representation of a magazine with pick-up roller;

FIG. 13 illustrates a schematic representation of a device according to FIG. 12 in a front view;

FIG. 14 illustrates a schematic representation of a magazine with different objects;

FIG. 15 illustrates a schematic perspective view of a further device according to the invention;

FIG. 16 illustrates a schematic representation of a further device according to the invention; and

FIG. 17 illustrates a schematic representation of a further device according to the invention.

### DETAILED DESCRIPTION OF THE EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

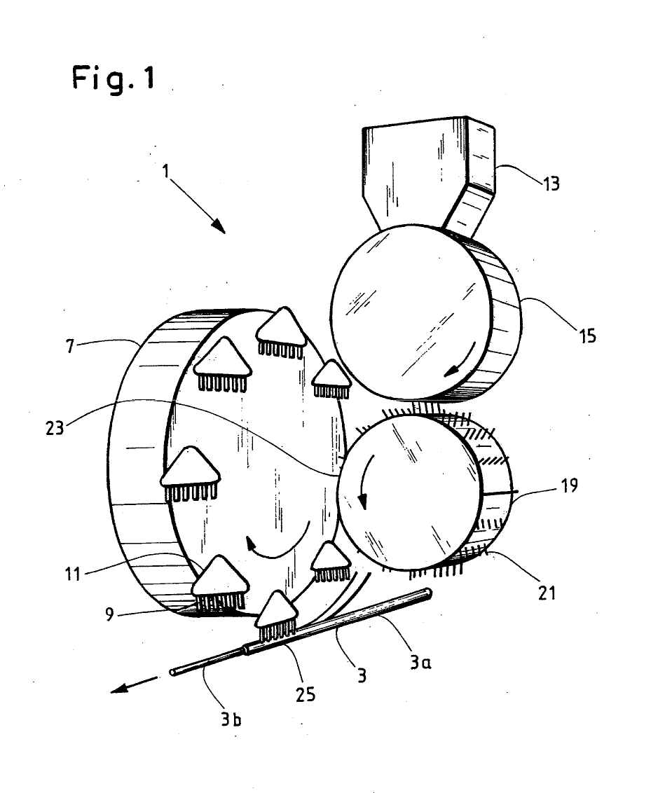

The FIGS. 1 to 6 represent schematically and in perspective, in an overview and in detail, a first exemplary embodiment of a device 1 according to the invention for inserting objects 5 into an endless filter rod 3 of the tobacco processing industry.

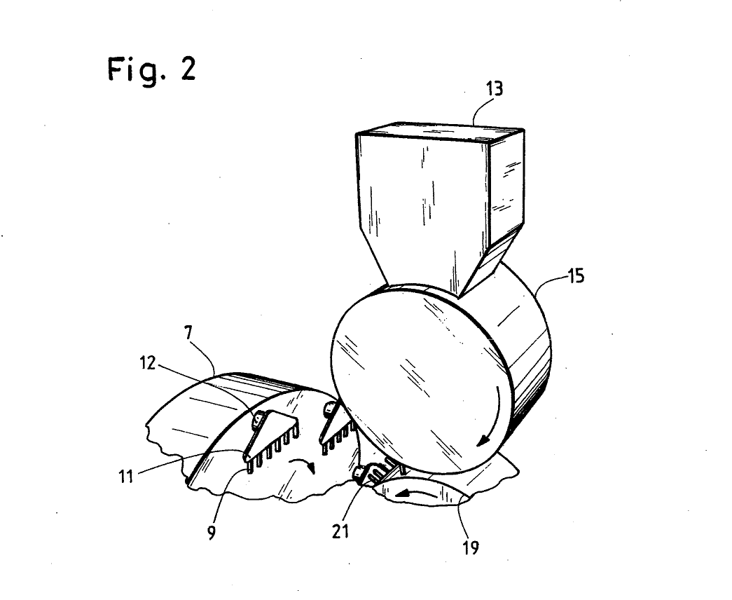

FIG. 1 shows the device 1 according to the first exemplary embodiment in overview. For clarity, some small-scale details are not shown; however, they are shown in the following FIGS. 2 to 6, and described.

A section of the endless filter rod 3 is shown in the lower area of FIG. 1. The conveyance direction of the endless filter rod 3 is schematically represented by an arrow in the extension of the endless filter rod 3. The endless filter rod 3 in the exemplary embodiment according to FIG. 1, is conveyed in an area 3a with average compaction, proceeds through an insertion zone 25, and is subsequently further compacted so that then, an endless filter rod 3b is further conveyed that is compacted to final compaction, and possibly enclosed with a strip of paper plugwrap.

The device 1 comprises an object conveying device 7, which in the example shown is also designated as a spider, a trough transmission, or in general, as an insertion wheel. The direction of rotation of the object conveying device 7 is shown by an arrow on the surface of the object conveying device 7 facing toward the viewer. The object conveying device 7 has eight insertion shoes 11, one of which is covered in the perspective representation by a transfer drum 19. The insertion shoes 11 each have a row of six rod-shaped receiving elements 9 for objects.

Each of the insertion shoes 11 can rotate with respect to the object conveying device 7 about an axis of rotation that is parallel to the axis of rotation of the object conveying device 7. The rotation preferably occurs such that in the course of one rotation of the object conveying device 7, the respective insertion shoe 11 remains constant in its absolute orientation in space. The receiving elements 9 of each insertion shoe point downward in the exemplary embodiment according to FIG. 1.

At the lower turning point of the receiving elements 9, or respectively the insertion shoes 11, the endless filter rod 3 is disposed tangentially to the conveying track of the tips of the receiving elements 9, so that at the lower turning point, these dip into the endless filter rod 3 in the insertion zone 25. At this location, the objects, which are not represented in FIG. 1, are released by the receiving elements 9 so that they remain in the blind hole-like recesses in the endless filter rod 3, and are further conveyed with the endless filter rod 3.

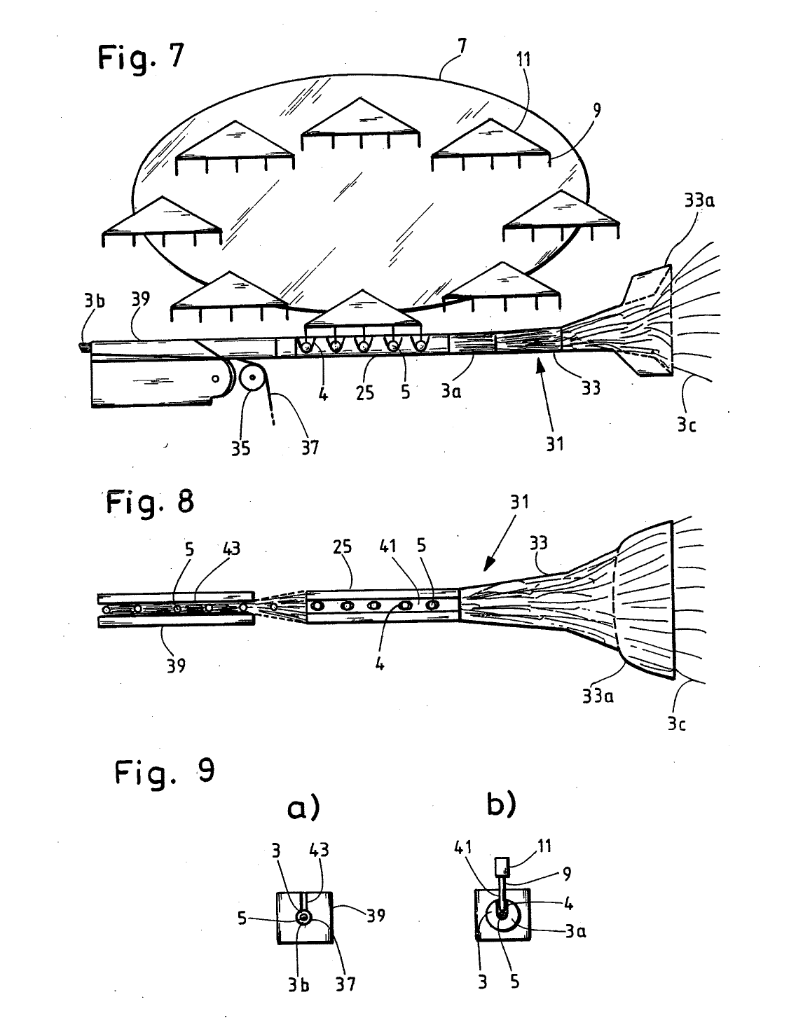

In the area of the insertion zone 25, each insertion shoe can also have an additional rotation kinematic about its own axis of rotation, in order to match the speed of the objects for a longer time to the speed of the endless filter rod 3, and in this manner to reduce the width of the respectively created blind hole-like recess 4. Corresponding blind hole-like recesses 4 are shown in the FIGS. 7 to 9, 16c and 17 for example. Such recesses are also created in the exemplary embodiments according to FIGS. 1 to 6 and the further figures.

FIG. 1 shows that the receiving elements 9 at the insertion shoes 11 of the object conveying device 7 receive objects at a receiving position 23 from a transfer drum 19, which has several rows of suction rods 21 on its peripheral surface. The distances of the suction rods 21 in each of the rows on the transfer drum 19 correspond to the distances between the receiving elements 9 on the insertion shoes 11. The direction of rotation of the transfer drum 19 is also indicated by an arrow on the front surface of the transfer drum 19.

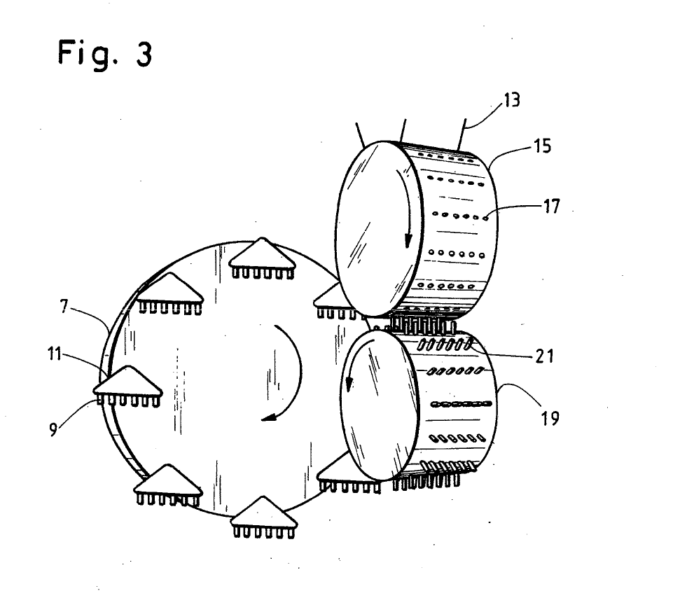

The transfer drum 19 receives the objects, not shown, from a pick-up drum 15, which has troughs not shown in FIG. 1, in which the objects are held via suction air. Such troughs are shown for example in FIG. 3. The direction of rotation of the pick-up drum 15 is shown in FIG. 1 by an arrow on the pick-up drum 15. The pick-up drum 15 removes the objects in several rows from a magazine 13.

If the objects are fluid-filled capsules that up to now could be removed from a magazine at a rate of approximately 3000 capsules per minute, with the device according to the invention represented in FIG. 1 capsules or objects can be inserted into the endless filter rod 3 at a rate of 18,000 per minute.

FIG. 2 shows a schematic perspective detail representation of the device 1 according to the invention according to FIG. 1. It can be seen here that the capsules, not shown, are transferred from the magazine 13 using the pick-up drum, in the direction of the arrow, to the transfer drum 19, only partially shown, with suction rods 21, from which the objects in turn are transferred to the receiving elements 9 of the insertion shoes 11 of the object conveying device 7. In FIG. 2 it can be seen that the insertion shoes 11 each are disposed on the object conveying device 7 by axis mount 12. Because the axis mount 12 of the insertion shoe 11 permits a rotation of the placement shoe 11 with respect to the object conveying device 7, by a rotation of the insertion shoe 11 counter to the direction of rotation of the object conveying device 7, a constant orientation of the receiving elements 9 at the insertion shoe 11 can be attained during the course of a rotation of the object conveying device 7. Also a changeable kinematic in the area of the insertion zone 25, among others, can be implemented for improvement of adapting the speed.

FIG. 3 shows a further schematic perspective detail view of the device 1 according to the invention according to FIG. 1. In this figure, the suction troughs 17 can be seen on the surface of the pick-up drum 15 that are each filled with an object, not shown. The suction troughs 17 are disposed in individual rows, each having six suction troughs 17, which correspond both in number and in distance to the six receiving elements 9 at each insertion shoe 11 of the object conveying device 7. This geometry also corresponds to the alignment and the arrangement of the suction rods 21 at the subsequent transfer drum 19.

At the lowest point of the pick-up drum 15 and at the highest point of the transfer drum 19, the suction rods 21 of the transfer drum 19 are flush with the suction troughs 17 of the pick-up drum 15. By switching off the suction air, for example, at this location of the pick-up drum 15 and switching on the suction air at the suction rods 21 of the transfer drum 19, the objects are transferred from the suction troughs 17 of the pick-up drum to the suction rods 21 of the transfer drum 19.

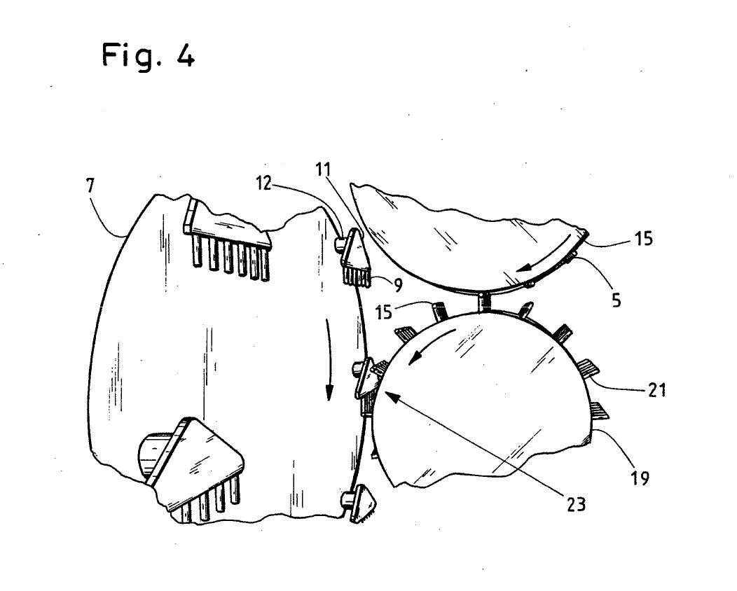

FIG. 4 schematically shows in a further perspective detail representation the transfer of objects 5 from the pick-up drum 15 to the transfer drum 19, and further to the receiving elements 9 of the insertion shoes 11 of the object conveying device 7.

The objects 5 are disposed in rows of six objects each, initially in the suction troughs 17 of the pick-up drum 15. They are further conveyed in the direction of the arrow to the lower turning point of the pick-up drum 15, at which they are received by suction rods 21 of the transfer drum 19. The distances between consecutive rows of suction troughs 17 on the pick-up drum 15 corresponds to the corresponding distances of consecutive rows of suction rods 21 on the transfer drum 19. The peripheral speed at the periphery of the pick-up drum 15 corresponds in this case to the peripheral speed at the tips of the suction rods 21 of the transfer drum 19.

From the upper turning point of the transfer drum 19, the objects 5 are further conveyed by approximately 90° to the transfer position 23. At this location, the objects 5 are received by the receiving elements 9 of an insertion shoe 11 of the object conveying device 7.

The consecutive insertion shoes 11 on the object conveying device 7 have a substantially greater distance from each other than the consecutive rows of suction rods 21 at the transfer drum 19. The conveying speed at the object conveying device 7 is also significantly greater than the conveying speed of the objects 5 on the transfer drum 19, so that each time when a row of suction rods 21 of the transfer drum 19 arrive at the transfer position 23, a subsequent insertion shoe 11 with receiving elements 9 has likewise arrived at the position. The tips of the receiving elements 9 are located at the transfer position 23 at the location of the objects 5 so that they receive the objects 5.

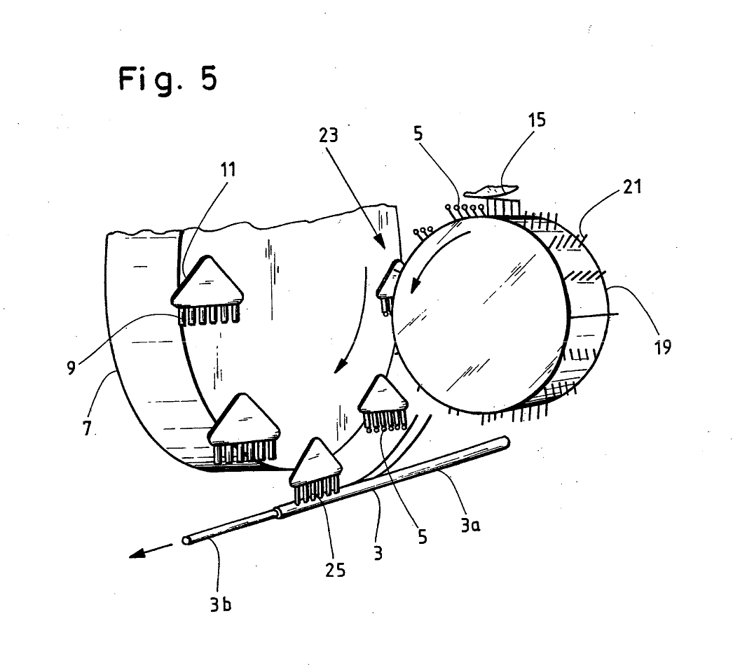

FIG. 5 shows a further detail from the device 1 according to the invention according to FIG. 1 in a schematic perspective representation. In the further course of conveying the objects 5 on the object conveying device 7, the objects 5 arrive in the insertion zone 25. The relative positioning of the conveying track of the objects 5 on the receiving elements 9 of the insertion shoes 11 with respect to the endless filter rod 3 is selected such that due to the tangential guidance of the track with the endless filter rod 3, the objects 5 are inserted centrally into the endless filter rod 3. The receiving elements 9 with the objects 5 disposed thereon, dip into the endless filter rod 3, without completely boring through it. The objects 5 are inserted into their blind hole-like recesses 4, in particular centered, in the endless filter rod 3.

After inserting the objects 5, the insertion shoes 11 move further on their circular or elliptical track, and are therefore pulled out again from the endless filter rod 3. At this location, the objects 5 are located in the endless filter rod 3 so that the receptacles of the receiving elements 9 are empty. After a further rotation of approximately 270°, the insertion shoes 11 are again moved along to the receiving position 23, where they receive new objects 5.

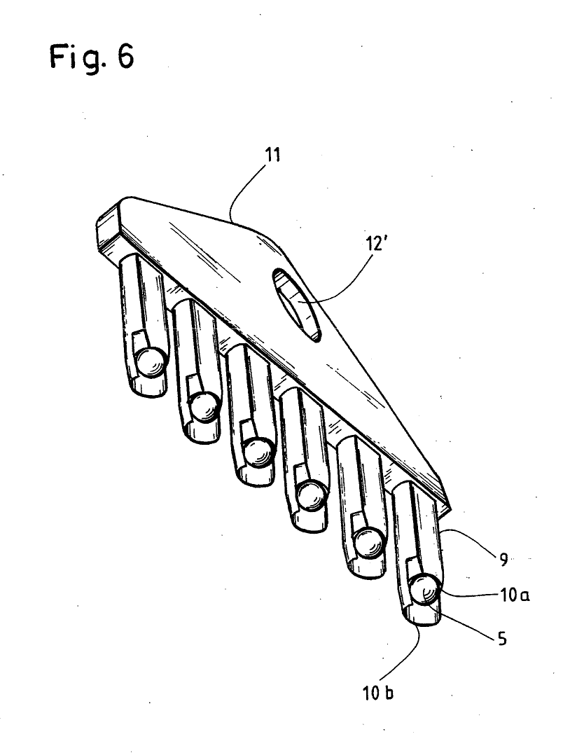

FIG. 6 shows an insertion shoe 11 of a device according to the invention, in particular according to FIGS. 1 to 5, in a schematic perspective representation. As in the prior figures, the insertion shoe 11 has six rod-shaped receiving elements 9 disposed in a row, each of which are provided with an object 5, having a spherical shape in the case shown. The insertion shoe 11 further has a central axis hole 12′ into which an axis mount 12 of the insertion shoe 11, for example according to FIG. 2, can be inserted.

Each of the rod-shaped receiving elements 9 has on its tip a receiving seat 10a upon which the object 5 sits, and also has an object protection spike 10b, which protects the object 5 from mechanical stress and destruction during creation of the blind hole-like recess in the endless filter rod 3. As also seen in FIG. 6, the rod-shaped receiving elements 9 in the case shown have a polygonal cross-section, in particular with rounded corners and/or side surfaces. However, receiving elements 9 with a circular cross section for example, can also be used.

The receiving elements 9 have suction air channels, not shown, for holding the objects 5 on the receiving seats 10a. In the case of spherical objects 5, the receiving seat 10a has a correspondingly concave receiving surface. The object protection spike 10b is shaped collar-like and projects in a substantially semicircular shape beyond the objects 5. When dipping the receiving elements 9 into an endless filter rod 3, initially the object protection spike 10b dips into the endless filter rod 3, and creates the blind hole-like recess 4, without stressing the object 5 in the process. In doing so, the object 5 is fastened by the receiving seat 10a. Subsequently, at the lower turning point of the object conveying device 7 according to FIGS. 1 to 5, the suction air is switched off and, therefore the objects 5 are inserted into the corresponding blind hole-like recesses 4 in the endless filter rod 3. The object protection spikes 10b can also be turned with respect to the represented version so that they precede the object 5 during penetration into the endless filter rod 3, thereby attaining an even better protection of the object 5.

Returning to FIG. 5, it is possible to provide the insertion shoes 11 in the area of the insertion zone 25 with an additional rotation about their axis mount 12, so that a further movement component is added. Thus, an insertion shoe 11, which can also be designated as a suction shoe, can in this area, initially before the penetration into the endless filter rod 3 as shown in the perspective representation in FIG. 5, be turned initially counterclockwise, and in the course of the insertion in the insertion zone 25 can be turned clockwise. Because the central conveying speed of the insertion shoe 11 at its axis fastening 12 is somewhat faster than the conveying speed of the endless filter rod 3, the speed difference, existing before and after the insertion, between the tips of the receiving elements 9 of the insertion shoes 11 and the endless filter rods 3 are compensated at least to some extent. Therefore the longitudinal extension of the blind hole-like recesses 4 is reduced.

FIG. 7 shows a schematic representation of an object conveying device 7 and an endless filter rod 3 with a rod conveying device 31. The insertion shoes 11 can be formed as seen in FIG. 6, however, in the example shown in FIG. 7, they have only five receiving elements 9. Deviating from the exemplary embodiment according to the FIGS. 1 to 5, in the exemplary embodiment according to FIG. 7 an elliptical track is used. This can be realized, for example, by selecting suitable planetary gears. The elliptical track shown in FIG. 7 has the advantage that at the lower turning point, the speed of the receiving elements 9 is adapted over a longer time, or respectively path, to the speed of the endless filter rod 3 than in the circular case. Due to the reduced perpendicular dipping speed, the insertion of objects 5 also is realized somewhat more gently than in the case of the circular track.

The lower part of FIG. 7 shows a rod conveying device 31. Uncompacted filter material 3a is guided, entering from the right, through a transport sleeve 33a into a garniture tongue 33 in which the filter material is precompacted. An endless filter rod 3a with average compaction exits from the garniture tongue 33, and enters into the insertion zone 25, in which objects 5 are inserted into the precompacted endless filter rod 3 with creation of blind hole-like recesses 4. These are slightly lengthened in the rod direction due to the varying speed of the objects 5. Instead of an insertion zone 25 in which the diameter and thus the degree of compaction of the endless filter rod 3 remains constant, an insertion zone 25 can also be provided with a diameter decreasing in the conveying direction of the endless filter rod 3.

After exiting from the insertion zone 25, the endless filter rod 3 reaches a garniture device 39 or format in which it is enclosed with a plugwrap or filter paper 37 that is supplied via a deflection roller 35. The finally compacted endless filter rod 3b exits from the garniture device 39.

FIG. 8 schematically represents the rod conveying device 31 according to FIG. 7 as seen from above. Again, uncompacted filter material 3c enters from the right, through a transport nozzle 33a into the garniture tongue 33, and is compacted there. The insertion zone 25 has a guide with a gap 41 for inserting objects 5. In this view, the blind hole-like recesses 4 have a somewhat elongated shape in the rod direction. Downstream of the insertion zone 25, the rod material is compacted further, and enters into the garniture device 39, where the objects 5 are finally embedded into the endless filter rod 3. The blind hole-like recesses 4 close at this location. Here, the garniture device 39 also has a gap 43.

FIG. 9 shows two schematic cross-sectional representations of the rod conveying device 31 according to FIGS. 7 and 8. FIG. 9a shows a cross-section of the garniture device 39. In this case, the endless filter rod 3 has a smaller diameter that corresponds substantially to the final diameter of the endless filter rod 3. The endless filter rod 3 has an object 5 in its center, around which it is compacted. In addition, the endless filter rod 3 is enclosed with a filter paper or respectively plugwrap 37.

FIG. 9b schematically shows a cross section through the rod conveying device 31 at the location of the insertion zone 25. The diameter of the endless filter rod 3 at this location is however substantially larger than in the area of the garniture device 39 of FIG. 9a. In FIG. 9b, the endless filter rod 3 is an endless filter rod 3a with average compaction.

It can also be seen in FIG. 9b that a rod-shaped receiving element 9 on an insertion shoe 11 dips at this location through the gap 41 into the endless filter rod 3, and deposits an object 5 in the center of the endless filter rod 3. In the process, a blind hole-like recess 4 is formed.

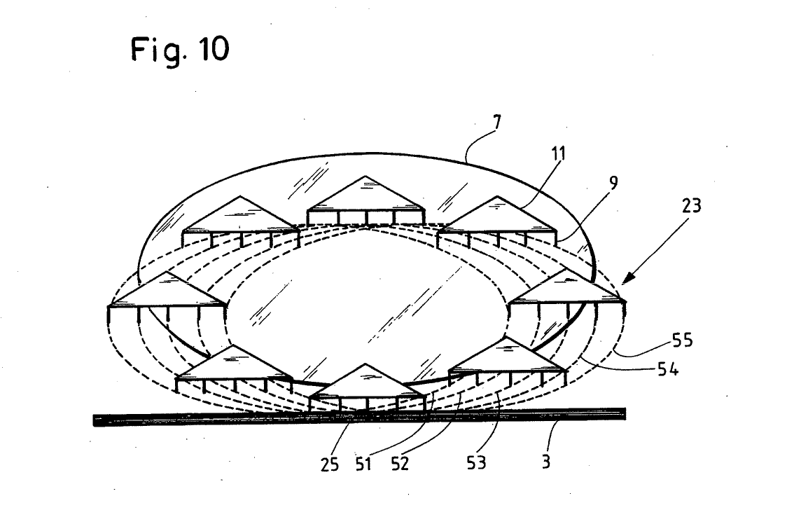

FIG. 10 shows a schematic representation of the conveying tracks 51 to 55 for objects 5 conveyed in parallel. The object conveying device 7 corresponds to that from FIG. 7. In both exemplary embodiments, each insertion shoe 11 has five uniformly spaced receiving elements 9. Each insertion shoe 11 is guided on an elliptical track, and during its rotation, maintains its orientation in space. This means that each receiving element 9 is guided on its own parallel offset, elliptical conveying track 51 to 55. Thus, each receiving element 9 has its own lower turning point in the endless filter rod 3, each of which is located in the insertion zone 25. The transfer position 23 is also shown.

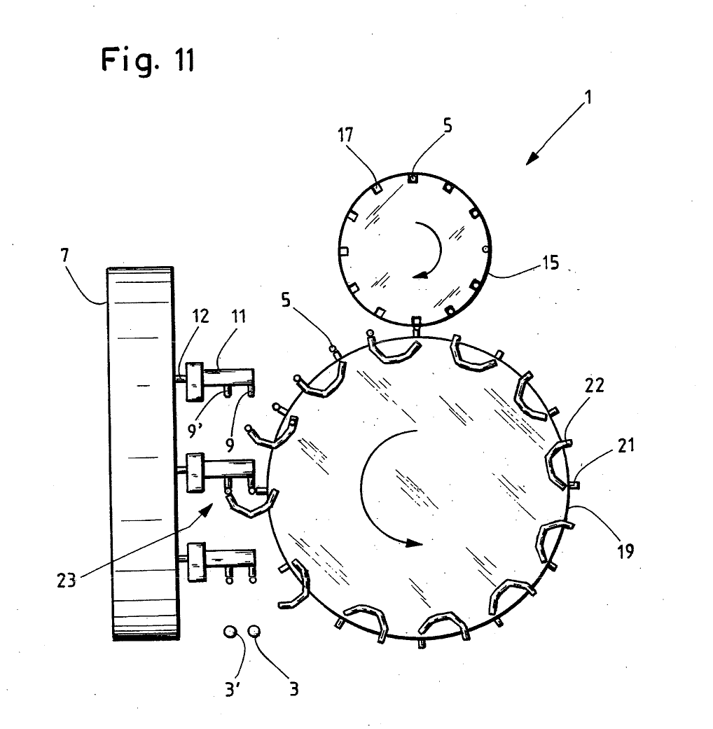

FIG. 11 shows a schematic representation of a further embodiment of a device 1 according to the invention. A pick-up drum 15 corresponds substantially to the pick-up drum 15 of the exemplary embodiment according to FIGS. 1 to 5. However, in contrast to the exemplary embodiment according to FIGS. 1 to 5, in this case, two parallel endless filter rods 3, 3′ are created in a twin rod machine, and provided with objects 5.

For this purpose, the transfer drum 19 not only has fixed suction rods 21 on the periphery of the transfer drum 19, but rather has also foldable suction rods 22 alternating with the suction rods 21. At the transfer point of the pick-up drum 15, the foldable suction rods 22 are located in a folded position in which they have the same height above the periphery of the transfer drum 19 as the suction rods 21. After the suction rods 21 and the foldable suction rods 22 have been populated with objects 5 from the pick-up drum 15, the foldable suction rods 22 unfold in order to align at the transfer position 23 in the radial direction from the center of the transfer drum 19 flush with the next following suction rod 21. At this location, objects 5 are transferred from the fixed suction rods 21 to a first row of the receiving elements 9, and from the foldable suction rods 22 to a second row of receiving elements 9′ of a modified insertion shoe 11. The receiving elements 9 of the first row deposit the objects 5 successively in the first endless filter rod 3, the receiving elements 9′ of the second row deposit the objects 5 in the second endless filter rod 3′.

After the transfer of objects 5 to the receiving elements 9, 9′, the foldable suction rods 22 fold back again into their starting position. A corresponding mechanism is described, for example, in the patent document DE 41 29 672 C2 of the applicant, which relates to a conveying device for conveying rod-shaped articles of the tobacco processing industry. The disclosure of DE 41 29 672 is expressly incorporated by reference herein in its entirety.

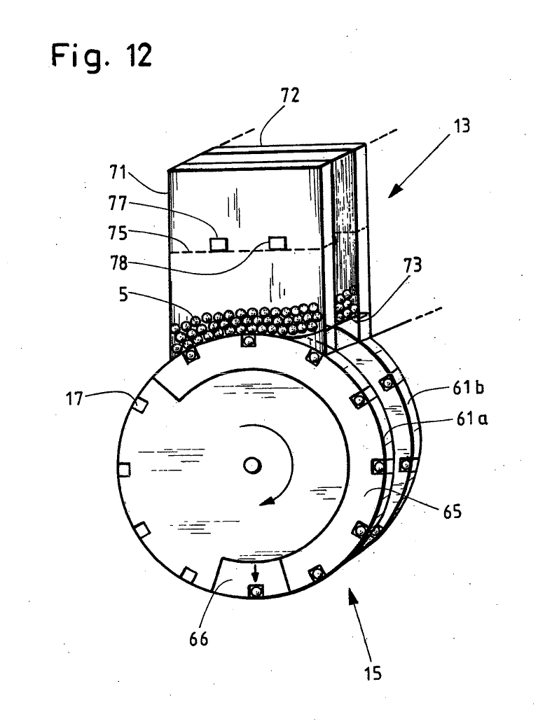

FIG. 12 schematically shows a detail of a magazine 13 and a pick-up drum 15 according to the invention. The magazine 13 and the pick-up drum 15 are both structured modularly. For this purpose, the magazine 13 has two partial magazines 71, 72, each of which has the width of the diameter of an object 5. The objects 5 are therefore stacked in the partial magazines 71, 72, each the width of one object.

The partial magazines 71, 72 each have a filling level limit 75, at which two filling level sensors 77, 78 are disposed whose signals are used for the purpose of interrupting or restarting a resupply of objects 5 into the partial magazines 71, 72.

Two pick-up disks 61a, 61b of the pick-up drum 15 are disposed below the partial magazines 71, 72. Each of the pick-up disks 61a, 61b has on its periphery a row of suction troughs 17 which in the area of the partial magazines 71, 72 are each filled with an object 5. To reduce the stress on the objects 5 during filling the suction troughs 17, the partial magazines 71, 72 each have a runout ramp 73 in the downstream area that ensures that the pressure on the objects 5 is reduced.

The pick-up disks 61a, 61b rotate with equal peripheral speed on a common axis. The direction of rotation is represented by an arrow on the front side of the pick-up disk 61a. It is schematically shown in the circumferential direction that the suction troughs 17 are provided with suction air or a vacuum in a suction area 65, in order to hold the objects 5 in the suction troughs 17. In an adjacent compressed air area 66 disposed at the lower turning point, this is reversed. The suction trough 17 is provided with compressed air to eject the object 5 held there. With this, the object 5 is transferred to the suction rod 21 of a transfer drum 19 according to FIGS. 1 to 5 or FIG. 11.

The modular construction shown in FIG. 12 permits a desired number of partial magazines to be operated in parallel next to each other, and pick-up disks to be used and their distances flexibly adjusted. This is advantageous for product changes because only the corresponding pick-up disks and partial magazines and their distances must be changed, without having to use a completely new device.

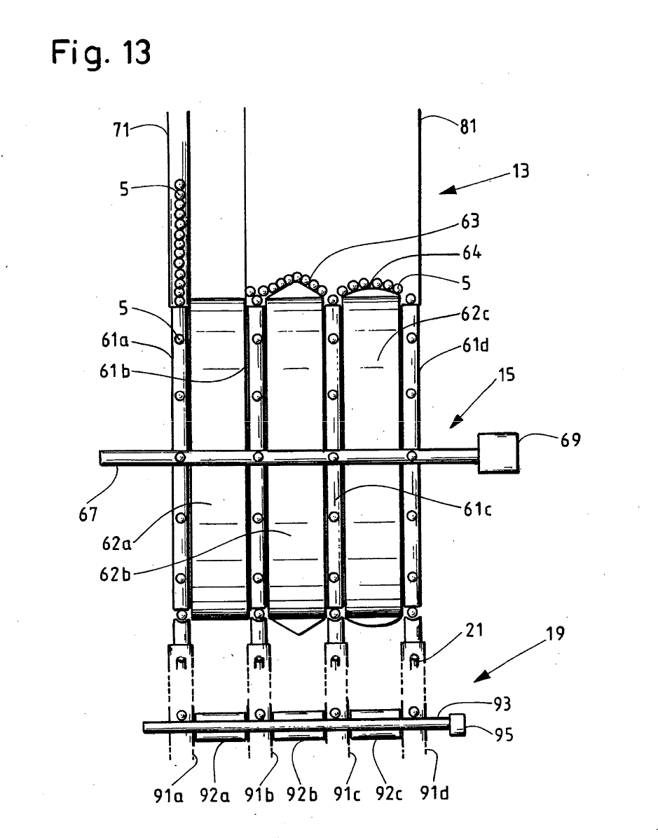

FIG. 13 schematically shows the manner in which the filling of the pick-up disks 61a to 61d can be realized. On the left side, using a partial magazine 71 it is shown that objects 5 are filled in a layer into the partial magazine 71, and are removed by a pick-up disk 61a. In addition, it is schematically shown in the lower area of FIG. 13 that the transfer drum 19 is also constructed modularly with multiple transfer disks 91a to 91d, which are held at a distance by dividing bodies or dividing disks 92a to 92c, and are disposed on a common axis 93 driven by a drive 95.

Likewise, the pick-up drum 13 has multiple pick-up disks 61a to 61d, which are distanced from each other by dividing disks 62a to 62c. In this manner, by a suitable selection of the thickness of the dividing disks 62a to 62c, different distances can be set. The pick-up disks 61a to 61d and the dividing disks 62a to 62c are disposed on a common axis 67 driven by a drive 69.

Along with the partial magazine 71 for only one row or respectively one layer of objects 5, a partial magazine 81 is provided for multiple rows that hold objects 5 ready for the pick-up disks 61b to 61d. In this case, the surfaces of the dividing disks 62b and 62c are contoured in order to ensure that the objects 5 arrive at the pick-up disks 61b to 61d. For this purpose, the surface of the dividing disk 61b is contoured with a cross section of a triangle or angled, whereas the surface of the dividing disk 62c is contoured with a cross section of a rounded surface 64. The partial magazine 71 can be filled with different type of objects 5 than those of partial magazine 81.

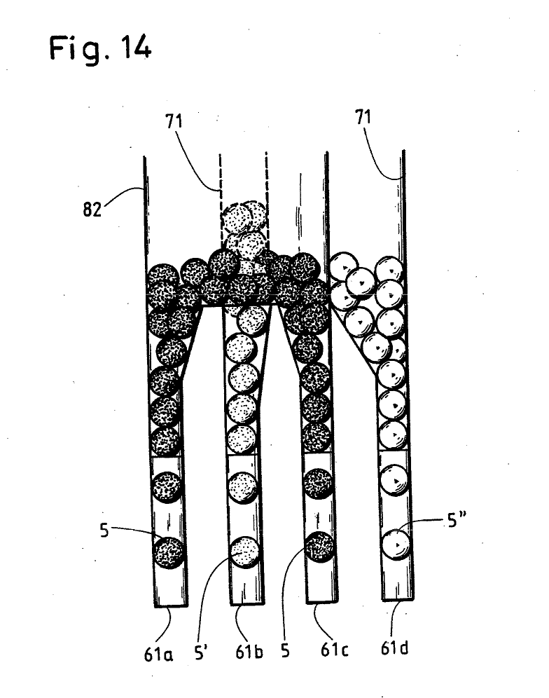

FIG. 14 shows schematically and as an example, how different pick-up disks 61a to 61d can be filled with different types of objects 5, 5′, 5″. On the left side it is shown that a partial magazine 82 is provided for two pick-up disks 61a, 61c, which are populated with a first type of objects 5. In the viewing direction pointing into the drawing plane, partially covered by the partial magazine 82, a partial magazine 71 is shown, that populates the pick-up disk 61b with a second type of objects 5′. Finally, on the right side, a further partial magazine 71 is shown for the pick-up disk 61d, that is filled with a third type of objects 5″. The partial magazines 71 and 82 have in common that they are tapered such that directly above the pick-up disks 61a to 61d, they each have the thickness of an object 5, 5′, 5″, so that it is possible to uniformly fill the suction troughs of the pick-up disks 61a to 61d.

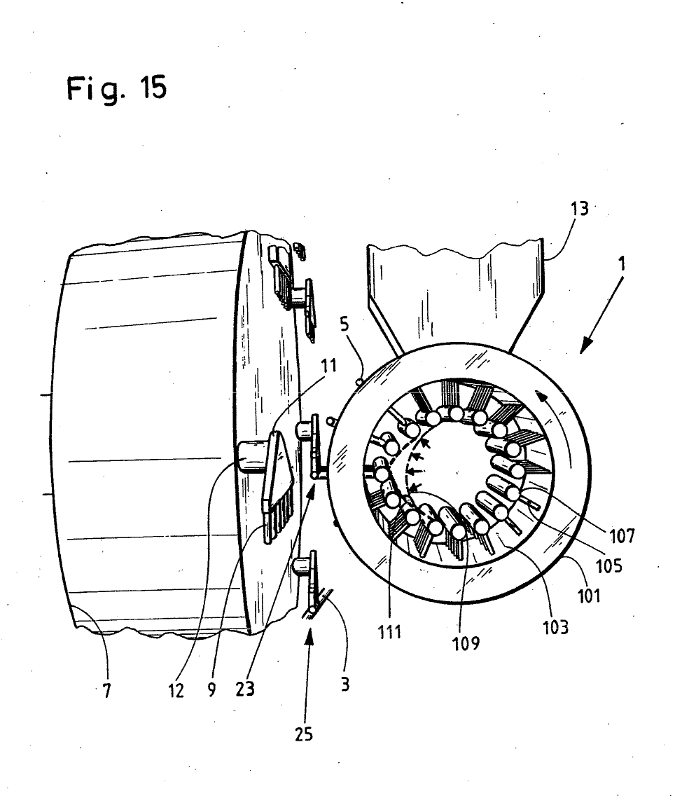

FIG. 15 shows a schematic perspective representation of an alternative design of a device 1 according to the invention. This differs from the design according to the invention according to FIGS. 1 to 5 in that instead of a combination of a pick-up drum 15 and a transfer drum 19, a combined pick-up and transfer drum 101 is provided. It rotates in the represented direction of the arrow beneath a magazine 13 from which it receives objects 5 in several rows. The combined drum rotates further to the transfer position 23 where the objects 5 are taken by the receiving elements 9 of an insertion shoe 11 of an object conveying device 7. All elements of the object conveying device 7 correspond to those of the exemplary embodiment according to FIGS. 1 to 5.

In FIG. 15, the pick-up and transfer drum 101 has a cavity 103 in which rows, disposed sequentially in the peripheral direction, are each provided with six radially shiftable suction rods 105. These are connected in each row to a respective suction air distributor 107, which together with the radially shiftable suction rods 105 are shifted in the course of a rotation of the pick-up and transfer drum 101 in the radial direction of the pick-up and transfer drum 101.

A track is shown schematically with the reference number 109, in which the suction rods 105 and the suction air distributor 107 are not shifted. The track, with reference number 111, is shown schematically with deflection.

The shiftable suction rods 105 are positioned in the course of the rotation of the pick-up and transfer drum 101 so that the suction rods 105 are radially retracted over a large part of the rotation. With this, suction troughs result at the outer periphery of the pick-up and transfer drum 101 that pull up at the upper turning point beneath the magazine 13, and remove objects 5 from the magazine 13. At this location, the mode of action and functionality of the pick-up and transfer drum 101 is the same as that of the exemplary embodiment from the FIGS. 1 to 5 and the FIGS. 11 to 14. The magazine 13 can be structured modularly, as described in the FIGS. 12 to 14.

After receiving objects, the suction rods 105 are moved radially outward along a control cam, which is designed or reproduced mechanically, for instance via an eccentric cam, or electronically. The control cam or deflection curve is designated with reference number 111. The radial shift is schematically represented in FIG. 15 also by arrows drawn in the cavity 103.

At the transfer position 23, the shiftable suction rods 105 project so far beyond the periphery of the pick-up and transfer drum 101 that they, or respectively the objects 5 disposed thereon, are received by the receiving elements 9 of the suction shoes or respectively insertion shoes 11. With the further rotation after the transfer position 23, the suction rods 105 are radially retracted again.

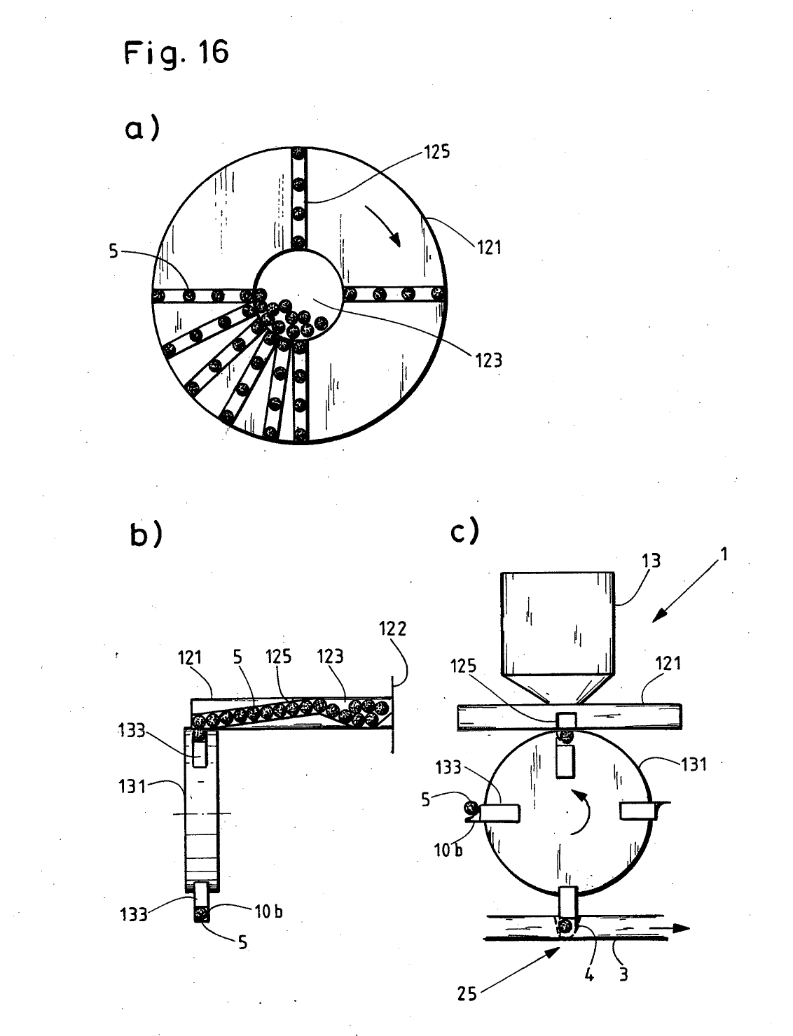

FIGS. 16a to 16c schematically show a further alternative device according to the invention from different directions. FIG. 16a schematically shows a top view of a removal device 121 that replaces a pick-up drum 15 according to the FIGS. 1 to 5, or 101 according to FIG. 15. The removal device 121 according to FIG. 16a is disposed horizontally and rotates about a vertical central rotation axis 122. Objects 5 are inserted into a central cavity 123, are pressed in the longitudinally extending chambers 125 by centrifugal force, and arrive in these chambers 125 at the outer periphery of the removal device 121.

The upper part of FIG. 16b shows half of the removal device 121 in cross section, starting from the vertical rotation axis 122. The central cavity 123 is filled with objects 5, which are pressed outward due to centrifugal force of the rotation of the removal device 121, i.e., pressed toward the left in the channel 125 in FIG. 16b. At the end of the channel 125 at the bottom of the removal device 121, there is an opening through which an object 5 arrives in each case into a receptacle of a rod-shaped receiving element 133 of an insertion wheel 131. The receptacle or respectively the rod-shaped receiving element 133 is preferably provided with suction air. FIG. 16b also shows that the rod-shaped receiving element 133 has an object protection spike 10b on its tip.

The insertion wheel 131 in FIG. 16b can be rotated about a horizontal axis. In the course of rotation, the rod-shaped receiving element 133 moves radially. At the upper turning point, at which objects 5 are removed from the removal device 121, the receiving element 133 is completely retracted; whereas at the lower turning point it projects radially outward to the maximum extent.

FIG. 16c schematically shows in a front view the embodiment of the device 1 according to the invention according to FIGS. 16a and 16b. Objects 5 arrive from an uppermost disposed magazine 13 into the central cavity 123 of the removal device 121, and are pressed by centrifugal force through the channels 125 shown in FIGS. 16a and 16b to the periphery. At this location, a receiving element 133 that is retracted in the radial direction into an insertion wheel 131, receives an object 5. The object 5, held at the receiving element 133 using suction air for example, is rotated in FIG. 16c in the counterclockwise direction with the insertion wheel 131. In the process, the respective receiving element 133 is moved radially out of the insertion wheel 131. At the same time, an object protection spike 10b precedes the object 5.

At the lower turning point, the receiving element 133 with the object 5 arrives at the insertion zone 25 in which an endless filter rod 3 is conveyed in this exemplary embodiment from left to right. In the course of this, the receiving element 133 penetrates, leading with the object protection spike 10b, into the endless filter rod 3, and creates a blind hole-like recess 4. During the process, the object 5 is not mechanically stressed. At the lower turning point, the object 5 is released, so that it is conveyed further with the rod 3 in the blind hole-like recess 4. In the further course of rotation of the insertion wheel 131, the receiving element 133 is again retracted in the radial direction in order to receive a further object 5 at the upper turning point. The retraction of the receiving elements 133 can occur very quickly after the release of the object 5, so that the blind hole-like recess is not widened too much.

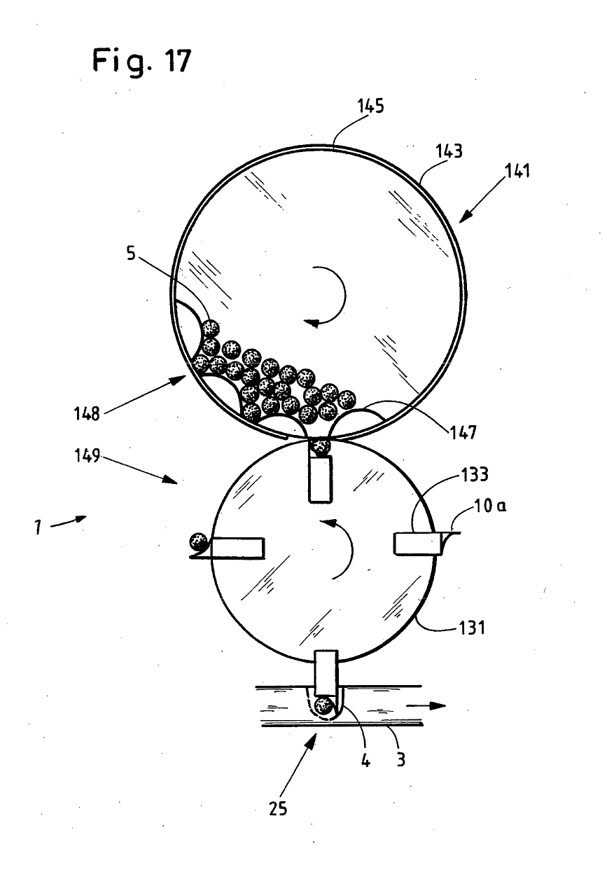

A further exemplary embodiment of the device 1 according to the invention according to FIG. 17 corresponds in the functionality of the insertion wheel 131 to that from FIG. 16. In contrast to FIG. 16, in FIG. 17, instead of a removal device 121, a removal device 141 is provided which rotates about a horizontal axis of rotation. This is a hollow drum that has a fixed outer cover 143 inside of which a reservoir drum 145 rotates. The reservoir drum is provided at its periphery with inward curved guide plates 147 between each of which channels 148 are disposed that have the width of an object 5.

By rotating the reservoir drum 145, the objects 5 are distributed at the periphery, preferably at the position of the channels 148. The cover 143 has an opening 149 at the lower turning point, at which objects 5 can exit through channels 148 or respectively openings. Here, they are received by a receiving element 133, and in the manner described in the exemplary embodiment according to FIG. 16 are further transported, and inserted into an endless filter rod 3.

All named characteristics, including those taken from the drawings alone, and individual characteristics, which are disclosed in combination with other characteristics, are considered alone and in combination as important to the invention. Embodiments according to the invention can be fulfilled through individual characteristics or a combination of several characteristics.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

### LIST OF REFERENCES

1 device
3, 3′ endless filter rod
3a endless filter rod in an average compaction
3b endless filter rod in final compaction
3c uncompacted filter material
4 blind hole-like recess
5, 5′, 5″ object
7 object conveying device
9, 9′ rod-shaped receiving element
10a receiving seat
10b object protection spike
11 insertion shoe
12 axis mount of the insertion shoe
12′ axis hole
13 magazine
15 pick-up drum
17 suction trough
19 transfer drum
21 suction rod
22 foldable suction rod
23 receiving position
25 insertion zone
31 rod conveying device
33 garniture tongue
33a transport nozzle
35 paper feed deflection roller
37 filter paper
39 garniture device
41 gap
43 gap
51-55 elliptical conveying track
61a-61d pick-up disk
62a-62c dividing disk
63, 64 contoured surface
65 suction area
66 compressed air area
67 axis
69 drive
71, 71′ partial magazine
72, 72′ partial magazine
73 runout ramp
75 filling level limit
77, 78 filling level sensor
81, 89 partial magazine for several rows
91a-91d transfer disk
92a-92c dividing disk
93 axis
95 drive
101 pick-up and transfer drum
103 cavity
105 shiftable suction rod
107 compressed air distributor
109 without deflection
111 with deflection
121 removal device
122 vertical rotation axis
123 central cavity
125 chamber
131 insertion wheel
133 rod-shaped receiving element
141 removal device
143 cover
145 reservoir drum
147 guide plate
148 channel
149 opening

What is claimed:

1. A method for inserting objects into at least one endless filter rod of the tobacco processing industry that is conveyed in the longitudinal axial direction, the method comprising:
creating at least one blind hole-like recess in the at least one endless filter rod;
inserting at least one object into the at least one blind hole-like recess in an insertion zone; and
compacting the at least one endless filter rod to enclose the object.

2. The method according to claim 1, before inserting the at least one object, conveying the at least one object on one of:
a section of a circular or elliptical track;
a section of a substantially circular or elliptical track; or
a section of a track including a superimposing of a circular or elliptical track with a further curved track.

3. The method according to claim 2, wherein the endless filter rod in the insertion zone is conveyed tangentially to the track, and
wherein a conveyance speed of the object during insertion in the insertion zone in the conveyance direction is at least essentially the same as the conveyance speed of the endless filter rod.

4. The method according to claim 1, wherein the at least one object during the creation of the blind hole-like recess, is pressed one of unprotected into the endless filter rod or protected from a direct stress.

5. The method according to claim 1, further comprising, before inserting the at least one object into the endless filter rod, holding the at least one object on a receiving element via suction air, and, in the insertion zone, transferring the at least one object to the endless filter rod by at least one of switching off the suction air and supplying compressed air.

6. The method according to claim 1, further comprising at least one of:
compacting the endless filter rod in the insertion zone; and
precompacting the endless filter rod before the insertion of the at least one object to a density that lies between the density of at least one of an uncompacted and unformed endless filter rod and a compacted and formed endless filter rod.

7. The method according to claim 1, wherein several objects are simultaneously inserted into respectively created recesses in the endless filter rod, and
wherein the several objects are conveyed on equally dimensioned circular or elliptical tracks that are shifted in the conveyance direction of the endless filter rod in parallel with respect to each other by a preset or presettable distance.

8. The method according to claim 1, wherein the at least one filter rod comprises at least two endless filter rods conveyed longitudinally axially in parallel to each other, and the method further comprises inserting at least one object in blind hole-like recesses created in the at least two filter rods.

9. A device for inserting objects into an endless filter rod of the tobacco processing industry, comprising:
a rod conveying device for longitudinal axial conveyance of an endless filter rod;
an object conveying device for objects to be inserted into the endless filter rod that defines a conveying track for the objects leading from a transfer position, at which the objects are transferred to the object conveying device, to an insertion zone, in which the objects are inserted into the endless filter rod;
the object conveying device comprising receiving elements structured for receiving objects to be inserted into the endless filter rod that are substantially rod-shaped at least in sections, in which each endless filter rod has a receiving seat with a retaining element in an area of a tip for an object,
the receiving elements are essentially perpendicularly alignable with the endless filter rod for inserting an object into the endless filter rod in the area of the insertion zone, in which the endless filter rod is disposed tangentially to the conveying track; and
a device for controlling a conveying speed of the objects in the rod conveying direction to match to a rod conveying speed so that the receiving elements dips into the endless filter rod to create blind hole-like recesses.

10. The device according to claim 9, wherein the conveying track between the transfer position and the insertion zone describes one of:
a section of a circular or elliptical;
a section of a substantially circular or elliptical track, or
a section of a track that results from superimposing a circular or elliptical track with a further curved track.

11. The device according to claim 9, wherein one of:
the receiving seat is located at a tip of the receiving element, or
the receiving element has a projection at its tip that protects the at least one object from a direct stress during creation of the blind hole-like recess.

12. The device according to claim 9, wherein the retaining element is one of a controllable, suction air connection, or a releasable clamping mechanism.

13. The device according to claim 9, wherein at least one of:
the insertion zone is located between a split garniture tongue and a garniture device for the endless filter rod, and
the endless filter rod entering the insertion zone has a conically decreasing diameter in the conveyance direction.

14. The device according to claim 9, wherein at least two receiving elements are arranged offset to each other for inserting objects into at least two endless filter rods conveyed longitudinally axially parallel to each other.

15. The device according to claim 9, wherein the rod-shaped receiving elements are disposed parallel in at least one row on a common insertion shoe that rotates on a circular or elliptical track on the object conveying device,
wherein the insertion shoe can be rotated to maintain its orientation in the course of the track, about an axis of rotation that is perpendicular to the plane spanned by the track.

16. The device according to claim 9, wherein the conveying track between the transfer position and the insertion zone comprises an arc of approximately 90° to 180°.

17. The device according to claim 9, further comprising:
a magazine for objects to be inserted; and
a pick-up drum for removing objects from the magazine.

18. The device according to claim 17, the pick-up drum is structured and arranged to transfer the objects to the object conveying device.

19. the device according to claim 18, wherein the pick-up drum comprises radially slidable suction rods.

20. The device according to claim 17, further comprising a transfer drum structured with suction rods and arranged to receive objects from the pick-up drum and to transfer the objects to the object conveying device.

21. The device according to claim 19, wherein, for transferring two or more rows of objects, a part of the suction rods comprises a folding mechanism.

22. The device according to claim 17, wherein at least one of the magazine, the pick-up drum and the transfer drum are modularly structured with drum disks of at least one of the pick-up drum and the transfer drum having a number and distance to each other that is adjustable.

23. A machine of the tobacco processing industry including the device according to claim 9.
